(19) United States
(12) Patent Application Publication
(10) Pub. No.: US 2025/0237833 A1
(43) Pub. Date: Jul. 24, 2025

(54) OPTICAL FIBER CABLE HAVING HIGH MODULUS, LOW CONTRACTION FILLER RODS

(71) Applicant: CORNING RESEARCH & DEVELOPMENT CORPORATION, Corning, NY (US)

(72) Inventors: Sylwester Kaczmarek, Strykow (PL); Andrii Kovalchuk, Lodz (PL); Sebastian Olszewski, Aleksandrów (PL)

(21) Appl. No.: 19/173,155

(22) Filed: Apr. 8, 2025

Related U.S. Application Data
(63) Continuation of application No. PCT/US2023/034332, filed on Oct. 3, 2023.
(60) Provisional application No. 63/415,001, filed on Oct. 11, 2022.

(51) Int. Cl. G02B 6/44

(52) U.S. Cl. CPC G02B 6/4434; G02B 6/4432

(57) ABSTRACT

Embodiments of the disclosure relate to an optical fiber cable. The optical fiber cable includes a cable jacket having an inner surface and an outer surface. The inner surface defines a central bore extending along a length of the optical fiber cable, and the outer surface defines an outermost surface of the optical fiber cable. A central strength member is disposed within the central bore. At least one buffer tube, containing a plurality of optical fibers, is disposed within the central bore. At least one filler rod is disposed within the central bore. The at least one buffer tube and the at least one filler rod are stranded around the central strength member. Each of the at least one filler rod includes a strength member and a polymer coating disposed around the strength member. The strength member is a fiber-reinforced plastic rod.

### CROSS-REFERENCE TO RELATED APPLICATIONS

This application is a Continuation of International Application No. PCT/US2023/034332, filed Oct. 3, 2023, which claims the benefit of priority of U.S. Provisional Application No. 63/415,001 filed on Oct. 11, 2022, the content of which is relied upon and incorporated herein by reference in its entirety.

### BACKGROUND

Optical fiber cables are deployed in a variety of different operating environments, including aerial, subterranean, underwater, and over the ground. In some environments, the optical fiber cable is carried in a duct. To install the optical fiber cable in the duct, such as by jetting or blowing, the optical fiber cable may need to have a certain diameter relative to the duct. This diameter may not be dictated by the number of optical fibers within the cable, and thus, the space within the cable may be filled with filler rods to maintain the desired shape and structure of the cable. However, replacing optical fibers with filler rods changes the composition of the optical fiber cable, which has an effect on the thermal performance of the optical fiber cable.

### SUMMARY

According to an aspect, embodiments of the disclosure relate to an optical fiber cable. The optical fiber cable includes a cable jacket having an inner surface and an outer surface. The inner surface defines a central bore extending along a length of the optical fiber cable, and the outer surface defines an outermost surface of the optical fiber cable. A central strength member is disposed within the central bore. At least one buffer tube is disposed within the central bore, and each of the at least one buffer tube contains a plurality of optical fibers. At least one filler rod is disposed within the central bore. The at least one buffer tube and the at least one filler rod are stranded around the central strength member. Each of the at least one filler rod includes a strength member and a polymer coating disposed around the strength member. The strength member is a fiber-reinforced plastic rod.

According to another aspect, embodiments of the disclosure relate to a six-position optical fiber cable. The optical fiber cable includes a cable jacket having an inner surface and an outer surface. The inner surface defines a central bore extending along a length of the optical fiber cable, and the outer surface defines an outermost surface of the optical fiber cable. The optical fiber cable also includes a central strength member. Six subunits are disposed in the central bore and stranded around the central strength member. The six subunits include at least one buffer tube and at least two filler rods. Each of the at least one buffer tube contains a plurality of optical fibers, and each of the at least two filler rods include a strength member and a polymer coating disposed around the strength member.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts a cross-sectional view of an optical fiber cable, according to an exemplary embodiment;

FIG. 2 depicts a graph of thermal cycling test results for optical fiber cables according to exemplary embodiments and for conventional optical fiber cables;

FIG. 3 is a graph of the strain as a function of applied force for an optical fiber cable according to an exemplary embodiment; and

FIG. 4 is a graph of the strain as a function of applied force for a conventional optical fiber cable.

### DETAILED DESCRIPTION

Referring generally to the figures, various embodiments of an optical fiber cable having improved low temperature performance are provided. As will be discussed more fully below, embodiments of the optical fiber cable include filler rods containing a strength member, such as a fiber-reinforced plastic rod. Optical fiber cables include a variety of components that have different properties, including different responses to changing temperature. In particular, plastic components within the cable expand and contract with changing temperature more than glass components or strength components contained within the optical fiber cable. The different extent of dimensional changes, especially contraction at low temperatures, can lead to unacceptable attenuation of signals carried by the optical fibers within the cable. The inclusion of a strength member in the filler rod decreases the ratio of plastic components to strength components within the optical fiber cable, limiting the effect of the contraction of plastic components on attenuation of the optical fibers in the cable. Exemplary embodiments of such an optical fiber cable will be described in greater detail below and in relation to the figures provided herewith, and these exemplary embodiments are provided by way of illustration, and not by way of limitation.

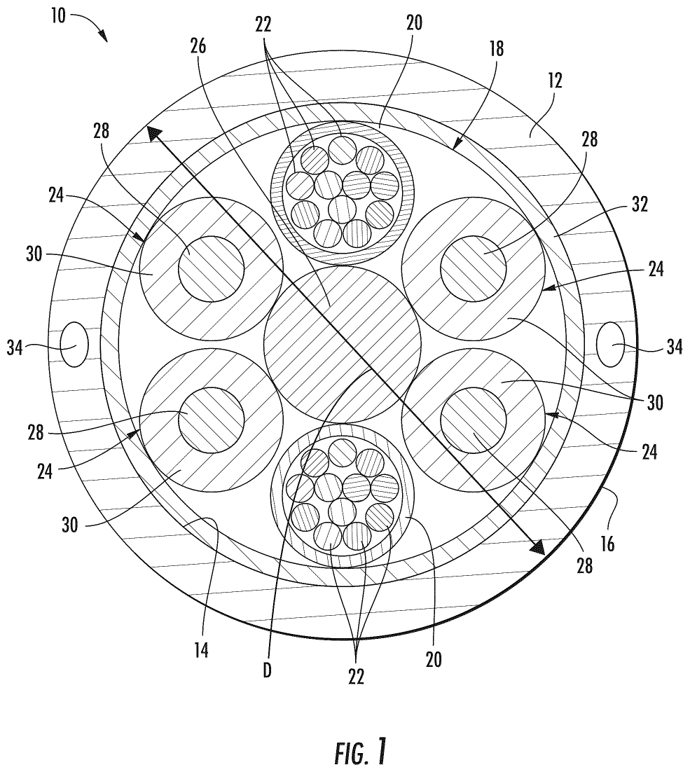

FIG. 1 depicts an example embodiment of an optical fiber cable 10. The optical fiber cable 10 includes a cable jacket 12 having an inner surface 14 and an outer surface 16. The inner surface 14 defines a central bore 18 that extends along the length of the optical fiber cable 10. The outer surface 16 defines an outermost surface of the optical fiber cable 10. The optical fiber cable 10 has a diameter D defined by the outer surface 16 of the cable jacket 12. In one or more embodiments, the diameter D of the optical fiber cable 10 is in a range from 3 mm to 7 mm. In one or more embodiments, the optical fiber cable 10 is configured to be fitted into a duct having an inner diameter in a range of 4 mm to 10 mm. For example, the optical fiber cable 10 may be configured to fit in a duct having an inner diameter of 6 mm, such as an 8/6 mm duct, and thus, in one or more such embodiments, the diameter D may be selected to be about 4.5 mm. In another example, the optical fiber cable 10 may be configured to fit in a duct having an inner diameter of 8 mm, such as a 10/8 mm duct, and thus, in one or more such embodiments, the diameter D may be selected to be about 6.2 mm.

Disposed within the central bore 18 is at least one buffer tube 20. In the embodiment shown in FIG. 1, the optical fiber cable 10 is known as a “six-position” cable because it can contain six subunits, which can be up to six buffer tubes 20. Disposed within each buffer tube 20 are a plurality of optical fibers 22, such as from four to thirty-six optical fibers 22, in particular twelve optical fibers 22 or twenty-four optical fibers 22. For an optical fiber cable 10 having six buffer tubes 20, the optical fiber cable 10 may contain up to 72 optical fibers 22 (for twelve-fiber buffer tubes) up to 144 optical fibers 22 (for twenty-four-fiber buffer tubes), or up to 216 optical fibers 22 (for thirty-six-fiber buffer tubes). However, not all six positions of the optical fiber cable 10 may be filled with a buffer tube 20. Instead, embodiments of the optical fiber cable 10 may contain one, two, three, four, or five buffer tubes 20, corresponding to an optical fiber cable 10 containing, e.g., 12, 24, or 36 optical fibers 22; 24, 48, or 72 optical fibers 22; 36, 72, or 108 optical fibers 22; 48, 96, or 144 optical fibers 22; or 60, 120, or 180 optical fibers 22. Positions that are not filled with a buffer tube 20 are instead filled with a filler rod 24. In this way, the combination of buffer tubes 20 and filler rods 24 will equal a total of six subunits within the optical fiber cable 10. It is to be appreciated, however, that a number of the subunits in the optical fiber cable 10 may be greater than or less than six.

In one or more embodiments, the optical fibers 22 have a fiber diameter of about 250 um or less. In one or more embodiments, the optical fibers 22 have a fiber diameter in a range of from about 160 um to 200 um, which increases the acceptable low-temperature shrinkage window. That is, an optical fiber cable 10 having optical fibers 22 with a comparatively small fiber diameter may experience acceptable attenuation losses over a larger window of dimensional changes to the optical fiber cable 10 as a result of fluctuations in temperature.

As shown in FIG. 1, the buffer tubes 20 and filler rods 24 are stranded around a central strength member 26. In one or more embodiments, the central strength member 26 is a fiber-reinforced plastic (FRP) rod. For example, the fiber-reinforced plastic rod may include fibers or yarns of glass, carbon, basalt, liquid crystal polymer (LCP), or aramid that could be bound together with a resin, such as a polyester resin or a UV-curable resin.

The optical fiber cable 10 may contain a plurality of subunits occupying virtual subunit positions, wherein the subunits consist of a plurality of buffer tubes 20 and a plurality of filler rods 24, wherein the buffer tubes 20 occupy a subset of the virtual subunit positions and the filler rods 24 occupy the remaining virtual subunit positions around the central strength member 26. The optical fiber cable 10 can have substantially any number of virtual subunit positions. In exemplary embodiments, the optical fiber cable 10 has 4, 5, 6, 7, or 8 virtual subunit positions.

Because of the potential difference in the number of buffer tubes 20 and filler rods 24 within the optical fiber cable 10, the thermal performance of the optical fiber cables 10 can vary. In particular, the inventors have found that the thermal performance of the optical fiber cable can be predicted from the ratio of plastic components (cable jacket, buffer tubes, and filler rods) to the strength component (central FRP rod). The plastic components have a much higher coefficient of thermal expansion (CTE) than the strength component. Thus, the plastic components expand at higher temperatures and contract at lower temperatures more than the strength component. Specifically, contraction of the plastic components at low temperatures can produce attenuation of the optical fibers at levels beyond acceptable standards. This problem is exacerbated because the routing (e.g., by blowing or jetting) of the optical fiber cables within ducts of a particular inner diameter requires that the optical fiber cable have a certain diameter (e.g., 4.5 mm cable in an 8/6 mm duct as mentioned above). Thus, the optical fiber cable is not made smaller for cables having a lower fiber count, and instead, the buffer tubs are replaced with filler rods. Conventionally, those filler rods were rods made entirely of polymer material, causing the ratio of plastic components to strength component to increase, thereby resulting in higher attenuation. For higher count optical fiber cables, such as optical fiber cables having five or six buffer tubes 20, the ratio of plastic components to strength components is sufficiently low (less than 8) to avoid unacceptable attenuation.

Table 1, below, provides various parameters for a conventional cable construction based on the number of buffer tubes (and thus optical fibers) in the optical fiber cable as well as the ratio of plastic components to strength component. Table 1 considers a six-position optical fiber cable having a cable jacket defining a cable diameter of 4.5 mm with a cross-sectional area of ^{6.31} mm2, buffer tubes having a diameter of 1.1 mm and a cross-sectional area of 0.295 mm², polymer filler rods having a diameter of 1.125 mm and a cross-sectional area of 0.99 mm², and a central strength member having a diameter of 1.2 mm and a cross-sectional area of 1.13 mm².

TABLE 1
Construction of Conventional Optical Fiber Cables

| | Plastic | Strength | | |
|---|---|---|---|---|
| | Components | Component | Ratio of | Cable |
| # of | Area (#1) | Area (#2) | Plastic | CTE |
| Fibers | (mm²) | (mm²) | #1 to #2 | (ppm/° C.) |
| 72 | 8.08 | 1.13 | 7.15 | 29.5 |
| 48 | 9.47 | 1.13 | 8.37 | 32.7 |
| 24 | 10.86 | 1.13 | 9.60 | 35.8 |

As can be seen in Table 1, the ratio of cross-sectional areas of plastic components to the cross-sectional areas of strength component increases as the fiber count decreases. At 72 optical fibers, the ratio remains below 8. However, for 48 and 24 optical fibers, the ratio is above 8. As buffer tubes are replaced with rods of polymer material, the amount of plastic components in the cable increases. Additionally, the CTE of the optical fiber cable increases (from 29.5 ppm/° C. to 35.8 ppm/° C.).

In order to decrease the ratio of the cross-sectional areas of plastic component to cross-sectional areas of strength component according to embodiments of the present disclosure, the conventional polymer filler rods are replaced with filler rods 24 having a strength member 28 with a polymer coating 30 as shown in FIG. 1. In one or more embodiments, the filler rods 24 include a strength member 28 in the form of an FRP rod (e.g., like the central strength member 26). Thus, for example, the FRP rod strength member 28 of the filler rod 24 may include fibers or yarns of glass, carbon, basalt, liquid crystal polymer (LCP), or aramid which could be bound together with a resin, such as a polyester resin or a UV-curable resin. Further, in one or more embodiments, the resin binding the yarns of the filler rod 24 together is selected to promote adhesion between the strength member 28 and the polymer coating 30.

In one or more embodiments, the strength member 28 has an elastic modulus of at least 40 GPa, at least 50 GPa, or at least 60 GPa. In one or more embodiments, the elastic modulus of the strength member 28 may be up to 1000 GPa. In one or more embodiments, the strength member 28 has a diameter that is from 25% to 90%, in particular 45% to 65%, of the diameter of the filler rod 24. In one or more embodiments, the diameter of the filler rod 24 is selected to match the diameter of the buffer tubes 20. In one or more embodiments, the diameter of the filler rod 24 or buffer tube 20 is from 1 mm to 1.5 mm.

According to one example, a six-position optical fiber cable 10 may have twelve-fiber buffer tubes 20 with a diameter of 1.1 mm, and the filler rod 24 (selected to have substantially the same diameter as the buffer tubes 20) includes a strength member 28 with a diameter of about 0.3 mm to about 0.9 mm, in particular about 0.5 mm to about 0.7 mm. According to another example, a six-position optical fiber cable 10 may have twenty-four fiber buffer tubes 20 with a diameter of 1.4 mm, and the filler rod 24 (selected to have substantially the same diameter as the buffer tubes 20) includes a strength member 28 with a diameter of about 0.35 mm to about 1.3 mm, in particular about 0.6 mm to 0.95 mm.

Disposed around the strength member 28 is a polymer coating 30 that has a thickness of about 0.05 mm to about 0.6 mm. In one or more embodiments, the polymer coating 30 comprises a polymer that is different form the polymer of the cable jacket 12 to prevent bonding between the filler rods 24 and the cable jacket 12. In one or more embodiments, the polymer coating 30 comprises at least one polymer selected form polypropylene, polyethylene, polyamide, polybutylene terephthalate, polyvinyl chloride, or polyethylene terephthalate, among other possibilities.

In one or more embodiments, the buffer tubes 20 and filler rods 24 are symmetrically arranged around the central strength member 26 (where possible). Advantageously, symmetrically arranging the buffer tubes 20 and filler rods 24 around the central strength member 26 prevents the introduction of a preferential bending axis. As shown in FIG. 1, the optical fiber cable 10 includes two buffer tubes 20, and the buffer tubes 20 are diametrically opposed with two filler rods 24 positioned between each buffer tube 20 on each side of the optical fiber cable 10. For an optical fiber cable having six virtual subunit positions and four buffer tubes 20, the positions of the buffer tubes 20 and the filler rods 24 are reversed with the two filler rods 24 diametrically opposed with the two buffer tubes 20 positioned between each filler rod 24 on each side of the optical fiber cable 10. For an optical fiber cable having six virtual subunit positions and three buffer tubes 20, the buffer tubes 20 and the filler rods may be alternately arranged around the central strength member 26.

Further, as shown in FIG. 1, one or more embodiments of the optical fiber cable 10 include a binder 32. In one or more embodiments, the binder 32 is a film formed (e.g., extruded) around the buffer tubes 20 and filler rods 24. In one or more embodiments, the binder 32 is formed from a thread, yarn, or tape wrapped around the buffer tubes 20 and filler rods 24. The binder 32 secures the buffer tubes 20 and the filler rods 24 around the central strength member 26. In one or more embodiments, the buffer tubes 20 and the filler rods 24 are stranded around the central strength member 26, such as S-stranded, Z-stranded, or SZ-stranded around the central strength member 26. In such embodiments, the binder 32 can be used to maintain the stranding of the buffer tubes 20 and filler rods 24 around the central strength member 26. In one or more embodiments, the binder 32 has a thickness in the range of 100 μm to 300 μm, more particularly about 200 μm. In one or more embodiments, the binder 32 in the form of a film is comprised of polyethylene, polypropylene, or another polyolefin compound.

In one or more embodiments, the optical fiber cable 10 includes an access feature 34 embedded in the cable jacket 12. In one or more embodiments, the access feature 34 is a strip of polymer dissimilar from the polymer of the cable jacket 12. For example, the access feature 34 may be a strip of polypropylene embedded in a polyethylene cable jacket 12. The dissimilar polymers do not form a strong bond at the interface between the polymers, and thus, when the cable jacket 12 is split at the access features 34, the cable jacket 12 will peel apart along the access features 34. In one or more other embodiments, the access feature 34 is a ripcord embedded in the cable jacket 12 that facilitates tearing of the cable jacket 12 for access.

Table 2, below, provides various parameters for an optical fiber cable 10 having filler rods 24 according to the present disclosure. As with Table 1, Table 2 considers a six-position optical fiber cable having a cable jacket 12 defining a cable diameter of 4.5 mm with a cross-sectional area of 6.31 mm², buffer tubes 20 having a diameter of 1.1 mm and a cross-sectional area of 0.295 mm², and a central strength member 26 having a diameter of 1.2 mm and a cross-sectional area of 1.13 mm². In the modeled cable 10, the filler rods 24 included a glass-reinforced plastic strength member 28 having a diameter of 0.5 mm. The overall diameter of the filler rod 24 was 1.125 mm. Thus, the area and a cross-sectional area of the strength member 28 of each filler rod was 0.195 mm², and the cross-sectional area of the polymer coating 30 was 0.795 mm².

TABLE 2
Construction of an Optical Fiber Cable
according to the Present Disclosure

| | Plastic | Strength | | |
|---|---|---|---|---|
| | Components | Component | Ratio of | Cable |
| # of | Area (#1) | Area (#2) | Plastic | CTE |
| Fibers | (mm²) | (mm²) | #1 to #2 | (ppm/° C.) |
| 48 | 8.99 | 1.52 | 5.90 | 26.3 |
| 24 | 9.90 | 1.92 | 5.17 | 24.2 |

As can be seen the plastic components of the cables 10 according to the present disclosure are less than the conventional cables shown in Table 1. In particular, for a forty-eight-fiber cable, the area of the plastic component is reduced from 9.47 mm² to 8.99 mm², and for the twenty-four-fiber cable, the area of the plastic component is reduced from 10.86 mm² to 9.9 mm². Further, the strength component of the cables is increased from 1.13 mm² to 1.52 mm² for the forty-eight-fiber optical fiber cable and from 1.13 mm² to 1.92 mm² for the twenty-four-fiber optical fiber cable. By decreasing the plastic component and increasing the strength component of the filler rods 24, the ratio of plastic component to strength component is significantly reduced to less than 6, in particular to 5.90 and 5.17, respectively, for the 48 fiber and 24 fiber optical fiber cables, which are both well below the desired ratio of less than 8. Further, as can be seen in Table 2, the CTE of the forty-eight-fiber optical fiber cable is reduced to 26.3 ppm/° C., and the CTE of the twenty-four fiber optical fiber cable is reduced to 24.2 ppm/° C.

In one or more embodiments, an optical fiber cable 10 according to the present disclosure has a cross-sectional area ratio (for a cross-section taken normal to a longitudinal axis of the cable 10 and looking along the longitudinal axis of the table 10) of plastic component to strength component of less than 8, in particular less than 7, and most particularly less than 6. In one or more embodiments, an optical fiber cable 10 according to the present disclosure and containing four buffer tubes 20 or less has a CTE of 30 ppm/° C. or less. In one or more embodiments, an optical fiber cable 10 according to the present disclosure and containing two buffer tubes 20 or less has a CTE of 25 ppm/° C. or less.

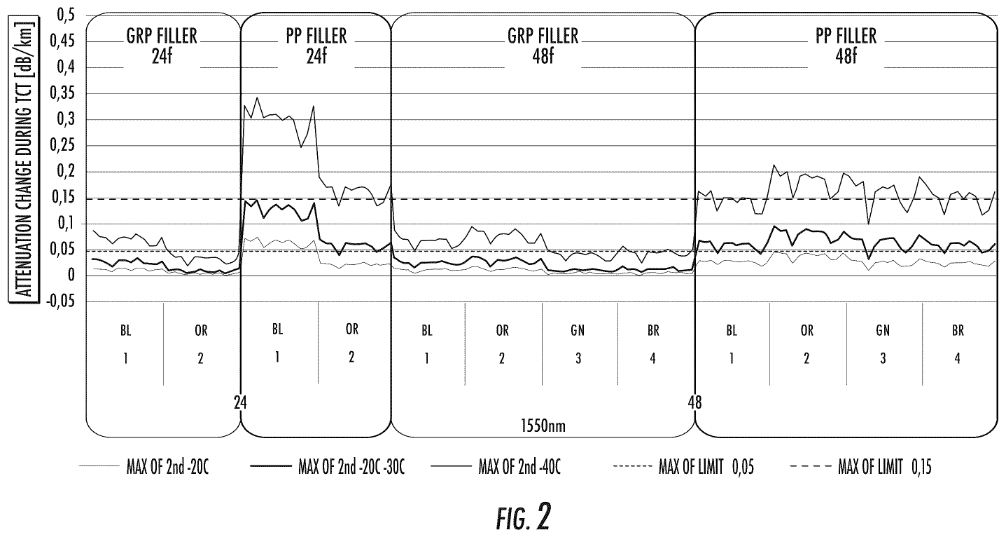

Optical fiber cables having twenty-four optical fibers (blue (BL) and orange (OR) buffer tubes) and forty-eight optical fibers (blue (BL), orange (OR), green (GN), and brown (BN) buffer tubes) were prepared according to the present disclosure (filler rods 24 with glass-reinforced plastic strength members 28) and underwent thermal cycling testing according to IEC 60794 -1-22. For comparison, conventional optical fiber cables having twenty-four and forty-eight optical fibers and fully polymeric (polypropylene) filler rods were prepared and also subject to thermal cycling testing. As per IEC 60794 -1-22, the cables were arranged in a testing chamber, and the temperature was increased to 80° C., decreased to −40° C., increased again to 80° C., and decreased again to −40°° C. Attenuation of optical fiber signals (at 1550 nm) carried over the optical fibers within the optical fiber cables is measured at various points during the thermal cycling. FIG. 2 depicts a graph of attenuation with the maximum attenuation of each of the twelve optical fibers in each buffer tube at the second cycle down to −20° C., −30° C., and −40° C. plotted.

As can be seen in FIG. 2, the attenuation of the optical fibers in the optical fiber cables according to the present disclosure having the filler rods with strength members was well below 0.15 dB/km even down to −40° C. Moreover, the attenuation in the optical fiber cables according to the present disclosure was below 0.05 dB/km at −20° C. and −30° C. In contrast, the conventional optical fiber cables having fully polymeric filler rods experienced attenuation above 0.15 dB/km at −40°° C. Further, for the twenty-four fiber conventional cable, attenuation was above 0.05 dB/km at both −30° C. and −20° C. For the forty-eight fiber conventional cable, attenuation was above 0.05 dB/km at −30° C. Based on the TCT results, replacing conventional polymeric filler rods with filler rods containing strength members reduces the contraction stress on the optical fibers, thereby reducing the attenuation at cold temperatures.

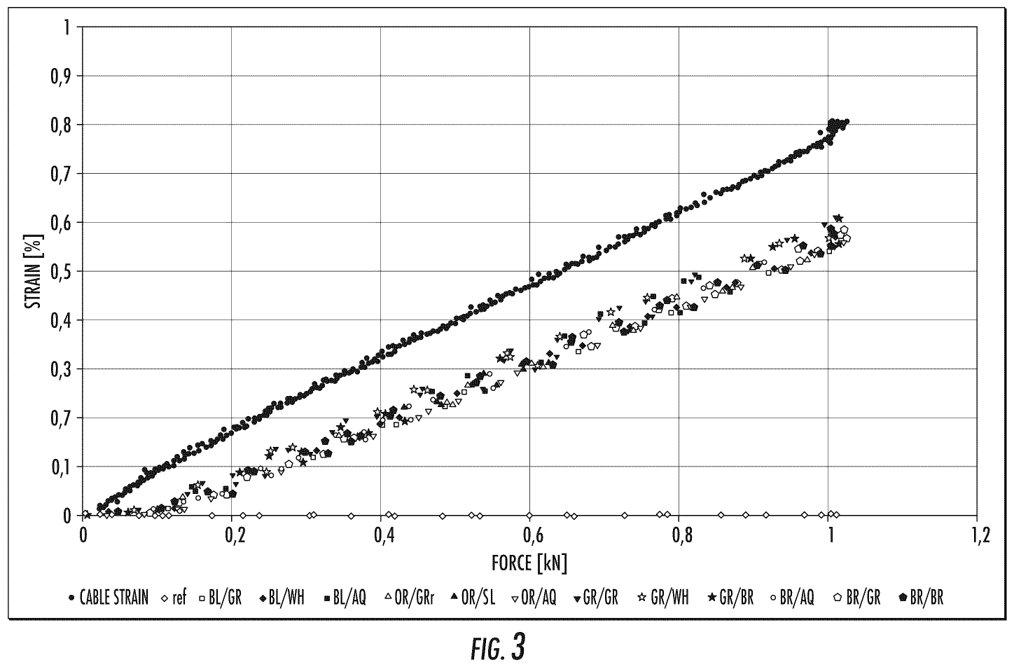

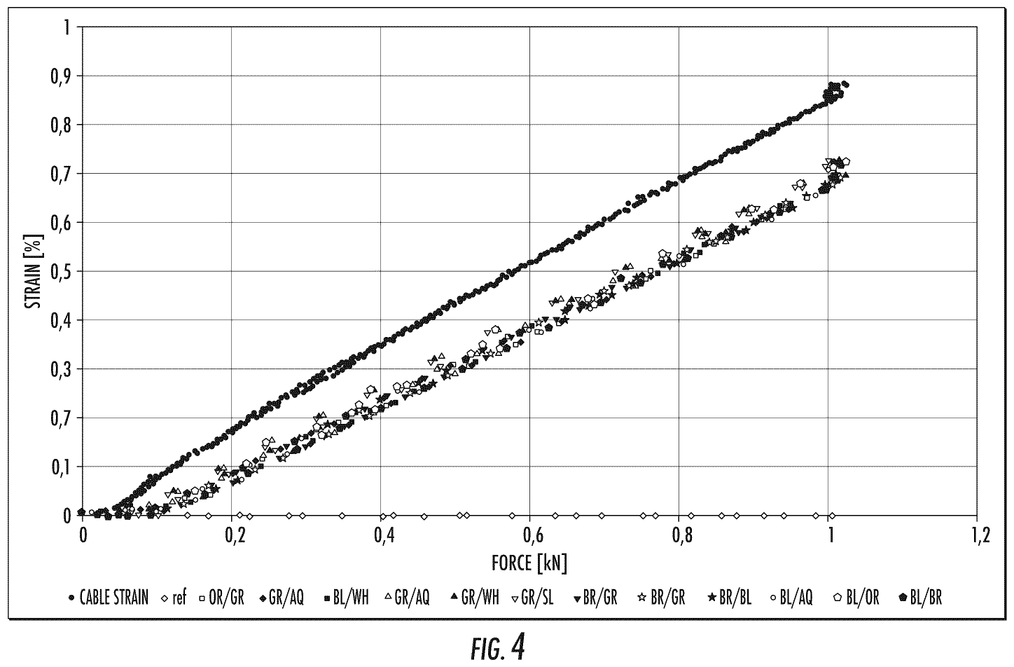

FIG. 3 depicts a graph of tensile performance testing of an optical fiber cable containing four buffer tubes with forty-eight total optical fibers according to the present disclosure. As can be seen in FIG. 3, the optical fiber cable was subjected to a force of up to 1 kN, and the strain was measured. At 1 kN of force, the strain on the cable was less than 0.85%, in particular reaching only about 0.8%, for the optical fiber cable according to the present disclosure. FIG. 3 also shows the strain on the individual optical fibers (referenced based on color of buffer tube and color of optical fiber (e.g., BL/GR=blue buffer tube and green optical fiber)), and at 1 kN of force, the strain on the optical fibers was about 0.6%. FIG. 4 depicts a graph of the tensile performance of a conventional optical fiber cable having fully polymeric filler rods and four buffer tubes with forty-eight total optical fibers. As can be seen, at 1 kN of force, the tensile strain on the cable was over about 0.85%, and the strain on the individual optical fibers was about 0.7%. Thus, not only do the filler rods 24 having strength members 28 according to the present disclosure enhance low temperature performance of the optical fiber cable 10, but the filler rods 24 also improve the tensile performance of the optical fiber cable 10 by increasing the strain window by about 0.1%.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an inner surface and an outer surface, the inner surface defining a central bore extending along a length of the optical fiber cable and the outer surface defining an outermost surface of the optical fiber cable;
a central strength member disposed within the central bore;
at least one buffer tube disposed within the central bore, each of the at least one buffer tube containing a plurality of optical fibers;
at least one filler rod disposed within the central bore;
wherein the at least one buffer tube and the at least one filler rod are stranded around the central strength member;
wherein each of the at least one filler rod comprises a strength member and a polymer coating disposed around the strength member, the strength member being a fiber-reinforced plastic rod.

2. The optical fiber cable of claim 1, wherein each of the at least one filler rod comprises a first diameter and the strength member of each of the at least one filler rod comprises a second diameter and wherein the second diameter is 25% to 90% of the first diameter.

3. The optical fiber cable of claim 1, wherein the fiber-reinforced plastic rod comprises yarns or fibers of at least one of glass, carbon, basalt, liquid crystal polymer, or aramid.

4. The optical fiber cable of claim 1, wherein the polymer coating comprises polyethylene, polypropylene, polyamide, polybutylene terephthalate, polyvinyl chloride, or polyethylene terephthalate.

5. The optical fiber cable of claim 1, wherein the cable jacket comprises a first polymer and the polymer coating of each of the at least one filler rod comprises a second polymer and wherein the second polymer is different from the first polymer.

6. The optical fiber cable of claim 1, wherein the at least one buffer tube and the at least one filler rod are arranged within the central bore so as not to create a preferential bend axis.

7. The optical fiber cable of claim 1, wherein the optical fiber cable comprises a plastic component including the cable jacket, the at least one buffer tube, and the polymer coating of each of the at least one filler rod, wherein the optical fiber cable comprises a strength component including the central strength member and the strength member of each of the at least one filler rod, and wherein a ratio of a first area of the plastic component to a second area of the strength component is less than 8.

8. The optical fiber cable of claim 1, wherein the optical fiber cable consists of six subunits, the six subunits comprising the at least one buffer tube and the at least one filler rod.

9. The optical fiber cable of claim 8, wherein the at least one buffer tube is no more than four buffer tubes and the at least one filler rod is at least two filler rods.

10. The optical fiber cable of claim 1, wherein the strength member of each of the at least one filler rod comprises an elastic modulus of at least 40 GPa.

11. A six-position optical fiber cable, comprising:
a cable jacket comprising an inner surface and an outer surface, the inner surface defining a central bore extending along a length of the optical fiber cable and the outer surface defining an outermost surface of the optical fiber cable;
a central strength member;
six subunits disposed in the central bore and stranded around the central strength member, the six subunits comprising at least one buffer tube and at least two filler rods;
wherein each of the at least one buffer tube contains a plurality of optical fibers; and
wherein each of the at least two filler rods comprise a strength member and a polymer coating disposed around the strength member.

12. The optical fiber cable of claim 11, wherein the outer surface of the cable jacket defines a cable diameter in a range from 3 mm to 7 mm.

13. The optical fiber cable of claim 12, wherein, when the optical fiber cable is loaded with a force of 1 kN, the optical fiber cable has a strain of less than 0.85%.

14. The optical fiber cable of claim 12, wherein the optical fiber cable comprises a plastic component including the cable jacket, the at least one buffer tube, and the polymer coating of each of the at least two filler rods, wherein the optical fiber cable comprises a strength component including the central strength member and the strength member of each of the at least two filler rods, and wherein a ratio of a first area of the plastic component to a second area of the strength component is no more than 6.

15. The optical fiber cable of claim 11, wherein the at least one buffer tube is four buffer tubes, wherein the at least two filler rods is two filler rods, and wherein the two filler rods are diametrically opposed in the central bore with two buffer tubes positioned between the two filler rods on each side of the optical fiber cable.

16. The optical fiber cable of claim 15, wherein a coefficient of thermal expansion of the optical fiber cable is 30 ppm/° C. or less.

17. The optical fiber cable of claim 11, wherein the at least one buffer tube is three buffer tubes, wherein the at least two filler rods is three filler rods, and wherein the three buffer tubes and three fille rods are alternately arranged around the central strength member.

18. The optical fiber cable of claim 11, wherein the at least one buffer tube is two buffer tubes, wherein the at least two filler rods is four filler rods, and wherein the two buffer tubes are diametrically opposed in the central bore with two filler rods positioned between the two buffer tubes on each side of the optical fiber cable.

19. The optical fiber cable of claim 18, wherein a coefficient of thermal expansion of the optical fiber cable is 25 ppm/° C. or less.

20. The optical fiber cable of claim 11, wherein the optical fiber cable experiences an attenuation of 0.15 dB/km or less on a second thermal cycle to a temperature of −40° C. when subjected to thermal cycling testing according to IEC 60794-1-22.
